(19) United States
(12) Patent Application Publication
(10) Pub. No.: US 2025/0229642 A1
(43) Pub. Date: Jul. 17, 2025

(54) INTELLIGENT TOWING SYSTEM AND METHOD FOR IMPROVED CONTROL AND EFFICIENCY

(71) Applicant: Wild Technologies, Inc., Santa Monica, CA (US)

(72) Inventors: Justin Rodenburg, Santa Monica, CA (US); Riley Rodenburg, Santa Monica, CA (US); Nathaniel Wynn, Anaheim, CA (US); Linus Lundberg, Los Gatos, CA (US); Kevin Baxter, Tulsa, OK (US)

(21) Appl. No.: 19/019,027

(22) Filed: Jan. 13, 2025

Related U.S. Application Data
(60) Provisional application No. 63/620,591, filed on Jan. 12, 2024.

(51) Int. Cl. B60L 15/20; B60R 16/03; B60S 9/04; B60T 8/17; B62D 59/04; G07C 5/08

(52) U.S. Cl. CPC B60L 15/20; B60T 8/1701; B62D 59/04; G07C 5/0816; B60L 2200/28; B60L 2210/10; B60L 2210/30; B60R 16/03; B60S 9/04

(57) ABSTRACT

An intelligent towing control system including: a microprocessor in communication with a trailer wheel motor and the trailer's electrically operated brakes; a load sensor; an accelerometer; a mechanical connection to the trailer; the microprocessor in communication with the accelerometer and the load sensor; the microprocessor in electrical communication with a battery; wherein the microprocessor is adapted for controlling the wheel motor and the electrically operated brakes to improve towing control of the trailer. A method includes: measuring the force of the trailer on the towing vehicle; measuring the acceleration condition of the trailer; measuring the angular direction change of the trailer; obtaining a result of the force, acceleration and angular direction change of the trailer; and, adjusting the towing mode of the trailer based on the result.

### CROSS-REFERENCE TO RELATED CASES

This application claims the benefit of U.S. provisional patent application Ser. No. 63/620,591, filed on Jan. 12, 2024, and incorporates such provisional application by reference into this disclosure as if fully set out at this point.

### FIELD OF THE INVENTION

The present invention relates, generally, to tow trailer platforms and specifically to tow trailer platforms that include onboard electrically powered motility and/or braking.

### BACKGROUND OF THE INVENTION

Electric tow vehicles are in their infancy and yet they have already been relegated to the same basic standards as most low-end electric vehicles and basic mechanical motivation of the wheels to ease the load on the towing vehicle via batteries and electric motors. There is so much more that an electric trailer platform is capable of.

Trailers have been around since the advent of the motor vehicle and very little has changed. The tow vehicle has a hitch that is connected to the trailer and it is largely responsible for pulling and braking both. Electric brakes have been added to trailers which watch for brake light signals or loading from a hydraulic piston connected to the hitch mechanism. Too little weight on the hitch and the trailer tends to fishtail, too much weight on the hitch and it removes weight on the front tires of the tow vehicle, reducing steerability, both situations leading to dangerous consequences.

Recreational vehicles (RV) add another wrinkle to the issue in that most RV users are not year-round trailer operators. They often lack the experience and knowledge to pull an RV trailer safely. Most are almost completely unable to even back a trailer. They have a target distance to travel and they simply hitch up and set off on a cross country journey with trailer loaded with large quantities of water, propane, supplies and other recreational materials. These types of trailers can be quite heavy and manipulating the tow vehicle's hitch to the proper load level is critical for a safe trip.

Electric vehicles have the torque to pull a trailer but their range is already limited, pulling a trailer would make a poor situation even worse, unusable range. There have been a few early attempts to electrify trailers to ease the load of pulling them. They generally use existing or similar to existing car batteries and electric motors. The existing electric trailer technology has the basic ability to assist but not to remove many of the effects of pulling a large trailer. Because so many people can't properly back a trailer some early electric trailers can be controlled to slowly drive unhitched by their own power to back into spaces or connect to a tow vehicle's hitch. This is done using a wireless app on a cell phone.

Many of today's RV users want to not just travel and park but to go off-grid. The idea of using such fuels as propane in an electric trailer is both problematic and against the ideals of individuals who would want an electric trailer. But the high energy requirements of HVAC, hot water, and pumps, and such are big challenges to a successful electric RV trailer.

### SUMMARY OF THE INVENTION

The present invention sets forth an intelligent towing control system for use with a trailer having electrically operated brakes and at least one wheel motor. This intelligent towing control system includes: a microprocessor in communication with a trailer wheel motor and the trailer's electrically operated brakes; a load sensor; an accelerometer; a mechanical connection to the trailer; the microprocessor in communication with the accelerometer and the load sensor; the microprocessor in electrical communication with at least one battery; wherein the microprocessor is adapted for controlling the wheel motor and the electrically operated brakes to improve towing control of the trailer.

The present invention also provides a method for controlling the towing mode of a trailer having electrically operated brakes and at least one wheel motor, the trailer connected to a towing vehicle. The preferred method of the present disclosure includes the steps of: measuring the force of the trailer on the towing vehicle; measuring the acceleration condition of the trailer; measuring the angular direction change of the trailer; obtaining a result of the force, acceleration and angular direction change of the trailer; and, adjusting the towing mode of the trailer based on the result.

As used herein, the term “towing mode” of the trailer shall mean the speed, direction of travel and/or the spatial position of the trailer and the relationship between the trailer, the tow vehicle, and/or the roadway. Non-limiting examples of the towing mode of the trailer include the presence and control of the sway of the trailer, potential breakaway condition of the trailer, physical location of the trailer, potential or actual collision of the trailer, physical conditions of the trailer including temperature, moisture, tire pressure(s), level condition, status and control of trailer systems, power and/or battery systems.

As used herein, the term “towing mode” could also include other features of the system and method of the present invention, including but not limited to: wheelbarrow mode, hill climb mode, acceleration mode, driving mode, parasitic charge mode, efficiency mode, sway control mode, breakaway condition control mode, traction control mode, anti-roll away detection and mitigation mode, collision avoidance mode, trailer propulsion mode, trailer braking mode, and wireless control mode.

As used herein, the term “roadway” means any surface on which a trailer may be operated, including but not limited to a paved road/highway, gravel road, logging road, grass and the like.

The system and method of the present disclosure combines several existing and evolving technologies to provide a system and method for improving trailer towing control and efficiency. The system and method of the present disclosure provides a diverse and computerized power source. It can store power, it can import power using a North American Charging Standard (NACS) connector or others, it can dispense power, it can convert power, and it can do all of these things even while off grid. The inventive device has the ability to control the self-motivation of the trailer, to propel its wheels while being towed under a variety of conditions and situations. To take the load off the towing vehicle, to add traction and stability to the towing vehicle, to allow inexperienced drivers to pull a trailer safely, and to automatically hitch to the tow vehicle.

Because so many people cannot properly back a trailer, the system can be controlled to slowly drive unhitched by the trailer's own power to back into spaces or connect to a tow vehicle's hitch. This is done using a wireless app on a cell phone after pressing an enable button, or by pressing an enable button and using a handle located on or in association with the trailer hitch to position the trailer. The system and method of the present disclosure thereby providing an intelligent control system which may be located on the trailer hitch or in communication with the trailer electromotive and braking apparatus.

The power center of the present system and method has the ability to convert power from one source to another. Power coming in from an AC mains connection could be sent to a battery charging circuit or to appliances in the trailer cabin, or to the towing vehicle or some combination of all the above. DC to DC switch-mode converters, inverters, and switches would be the preferred method of efficiently achieving the different voltages, both AC and DC, and locations that would be required. Similarly, the power could come from the towing vehicle, or solar panels, or from the wheels of the trailer while it is being towed (regeneratively for example). The trailer could harvest energy while being towed on a flat road or while going slowly, or on a downhill path. The system could store this energy in a battery or the trailer battery for use later when it would be assisting the tow vehicle while being towed at a higher rate of speed, during acceleration, or in an uphill climbing situation.

The system and method of the present invention could use heat pump technology for heating water, HVAC, refrigeration, and battery warming/cooling during inclement environmental periods. All decisions would be made by the present system with regard to the desired operating situation such as towing, off grid camping, grid connected camping, etc. This desired operating mode would be instructed by the user's input to the app. These electrical decisions would almost always favor the most efficient way to manage the available electric energy. The incoming power could vary from slow chargers, 120 volts AC, 240 volts AC, fast chargers, solar, external sources such as electric boats or motorcycles, tow vehicles, high voltages, low voltages, or generators and could be bi-directional to allow charging in either direction. Just about any power source would be a potential input/output source for the intelligent front end of the inventive system. It could determine the voltage available and then draw power until there was a noticeable dip in voltage or a complete drop out and then set the appropriate current based on that feedback. The present system would be able to output power to a tow vehicle, to traditional 12 VDC accessories, 120 VAC or 240 VAC appliances, power back to the mains, or shore power,

The system and method of the present disclosure could have a strain or load sensor attached or associated with the trailer hitch to determine towing load, both positive and negative. This sensor would have mechanical stops to protect from overload conditions. It could measure up to the point of those mechanical stops. A positive pull would be read by the system's central computer and it would apply more power to the wheel motor(s), a negative push would cause the computer to command the wheel circuitry to commence regenerative braking, and then mechanical brakes could engage if the negative push was too great (as sensed and determined by the present system). The strain or load sensor is most preferably a compression sensor including what is known in the art as a compression or cannister load cell, however the system could alternatively employ a load pin cell, a gyroscope, and an accelerometer to redundancy to ensure everything is working properly.

In the event the trailer is equipped to self-motivate, the system of the present disclosure could have an auto hitch mode where the trailer hitches itself to the tow vehicle when commanded. The present system and method could also do this by a Bluetooth connected app, or a handle that acts like a joystick on the trailer's tongue, or by physically tugging on a sensor loaded hitch. The trailer could have one or two motors, and two separate mechanical brakes. Backing or parking the trailer once unhitched could be done in a similar manner. Ideally a swivel jack that is situated near the trailer hitch would be electrically operated up and down as well as the hitch itself, both being ideally operated by the central computer of the system and method of the present disclosure. The system preferably includes an input for a trailer breakaway switch which cuts off power to the motor(s) if the trailer detaches from the tow vehicle. The breakaway switch also triggers the brakes to engage intelligently so as to steer the trailer on a path that would follow its last known path while it was still connected to the tow vehicle within the lane of travel on the roadway.

The system and method of the present disclosure ideally integrates a custom designed circuit board that includes a processor. This processor is in communication with and can read all the load sensors, accelerometer data, and gyroscope data, and send it to the system's Electronic Control Unit (ECU) which acts as the central computer. The circuit board also has a built in load sensor amplifier that allows a reduced amount of noise that could be introduced by the load sensor before transmitting sensed data to the main ECU.

In a machine learning model, the present system and method would be adapted to customize its algorithm to adapt to each drivers unique driving style. For example, if the driver is a hard braker, or has a lead foot, including unusual conditions and diagnostic features. The inventive system and method would collect user data, road conditions, reactions, and location, all to be collected and analyzed by the manufacturer. This analyzed data would allow software updates to existing algorithms to improve future towing experiences. The system could also detect unusual conditions and complete predictive diagnostics of the trailer system. For example, after a certain number of miles are traveled by the trailer, the system could suggest new tires or brakes etc. to the user via the mobile app. The inventive system and method would preferably include anti-roll away detection software, if it detects the trailer rolling when it is not supposed to, the system would apply brakes. The system could connect through the standard trailer connector ensuring that the trailer's braking precisely follows the tow vehicle's braking actions.

Each wheel of the trailer could be affixed with a speed sensor to verify that the speed requested by the system algorithm matches the actual speed at the wheels. There would be a series of proximity/collision detection sensors on its perimeter insuring that if anything obstructs the path, the software will automatically disable propulsion (by cutting off power to the motor(s) or applying the trailer brakes. The system algorithm would also integrate data from automotive grade Tire Pressure Monitoring System (TPMS) components to monitor trailer tire pressures for safe propulsion and optimal efficiency. Under inflated tire pressure can reduce efficiencies by several percent and cause tires to overheat, with blown tires being the catastrophic result. The system algorithm and sensor suite could detect poor traction and prevent wheel spin. Similarly implemented would be anti-trailer sway or wind sway by adjusting the speed of the trailer motor(s) or by applying the trailer brakes on the affected wheels to help restore traction and maintain stability when sway is detected, along with notifying the user/driver of the condition. There could be a system condition indicator positioned on the tongue of the trailer hitch, such as LEDs or LCDs.

The system of the present invention could be used in combination with a trailer hitch preferably having a universal mounting plate compatible with any standard hitch and these would include, without limitation:
A Class 1 Hitch-Weight capacity up to 2,000 lbs. Gross Trailer Weight (GTW) and 200 lbs. Torque Weight (TW)
A Class 2 Hitch-Weight capacity up to 3,500 lbs. GTW and 350 lbs. TW.
A Class 3 Hitch-Weight capacity up to 5,000 lbs. GTW and 500 lbs. TW.
A Class 4 Hitch-Weight capacity up to 10,000 lbs. GTW and 1,000 lbs. TW.
A Class 5 Hitch-Weight capacity over 10,000 lbs.
And Pintle Ring Hitches.

The system and method of the present disclosure would also work with trailers that have any number of axles and could come in a kit form to rapidly adapt to any trailer size or configuration.

The central computer of the present system and method would ideally allow for over the air updates, proactive diagnostics, monitoring electrical, battery, and mechanical health, app control, fleet control commands, and inertial sensor input.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

FIG. 1 shows a trailer frame including an electric motor adapted to operate with the system and method of the present disclosure depicted from a top view.

FIG. 2 shows the sensing trailer hitch including sensors of the system of the present disclosure depicted in a partially exploded isometric view.

FIG. 3 shows a side view of an exemplary intelligent electric trailer including the system and method of the present disclosure.

FIG. 4 is a block electrical diagram of the system and method of the present disclosure.

FIG. 5 is a block diagram of the circulating coolant system of the system and method of the present disclosure.

FIG. 6 is a block diagram of the central computer and processes and controlled components of the system and method of the present disclosure.

FIG. 7 depicts a front view of a trailer including collision avoidance sensors of the system and method of the present disclosure.

FIG. 8 depicts the system condition indicator of the system and method of the present disclosure.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

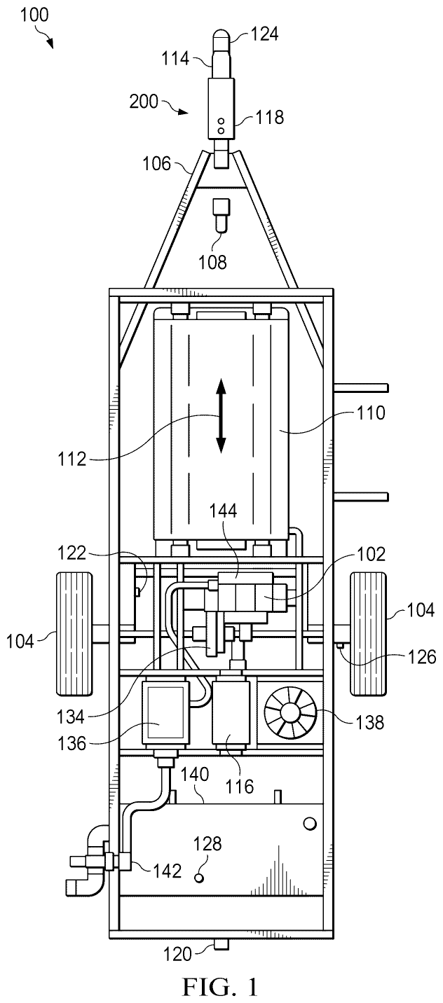

FIG. 1 shows an intelligent electric trailer's frame 100. There are one or more motors 102 which drive the wheels 104 and electrically operated brakes. There is a tongue 106 that has a sensing trailer hitch 200, and a tongue jack 108. There is a battery pack 110 that can be electromechanically moved forwards and backwards 112 in the frame to allow greater or lesser weight on the hitch coupler 114. The central computer 116 can be placed anywhere and has sensors 118, 120, 122, 124, 126, 128 around the frame, and they consist of temperature, RADAR, LIDAR, ultrasonic, machine vision cameras, inertial, pressure, and strain gauge, as examples of type and location, but not by limitation. The motors 102 are driven by the motor controller 130. There is also a gear box 134, the on board charger (OBC) 136 which includes a DC/DC converter and an AC inverter. Other items are also present, such as the radiator's cooling fan 138, a camper trailer tank 140, a charge jack 142, and coolant pump 144.

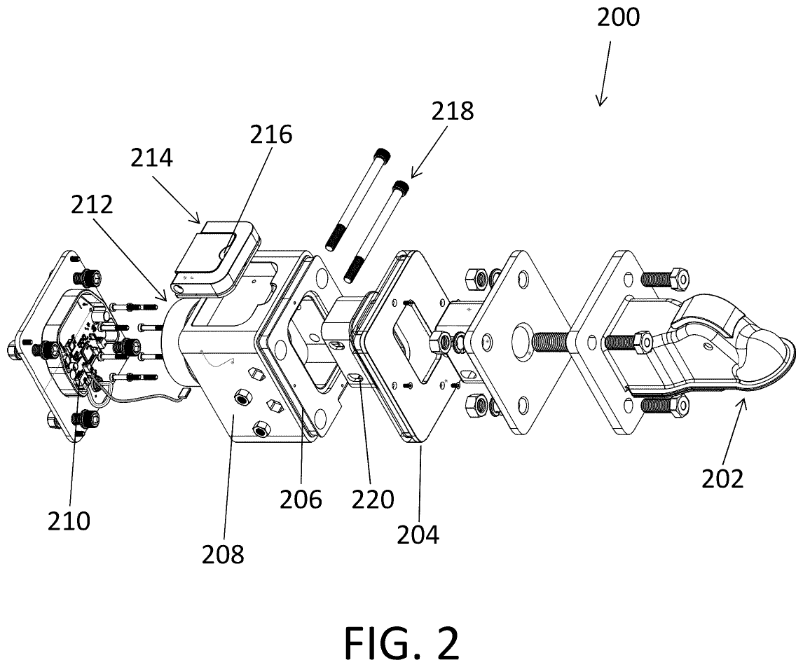

FIG. 2 is an isometric view of a trailer hitch 200 adapted for use with the system and method of the present disclosure. The trailer's coupler 202 is interchangeable with different ball sizes or the various types or classes of hitch 202. The hitch coupler 202 could be manual or have an electro-mechanical actuator for fully automated hitching. Hitch 200 consists of several parts beyond the coupler 202, including a slide sleeve 208, a moving center bar 204, oval shaped limit slots 220, a load sensor 212, mechanical restraining bolts 218, and a control board PCB 210. The moving center bar 204 is loosely contained in the sleeve 208, and is kept in place by the mechanical restraining bolts 218 which pass through oval shaped limit slots 220. This allows the moving center bar 204 to move just enough to push or pull on the load cell (load sensor) 212 which actuates the load sensor on one side while the other side of the load cell 212 is attached directly to the sleeve 208, all with the moving center bar 204 being securely captured.

Handle 214 can flip up and act like a joystick in communication with the system control board/microprocessor/PCB 210 which is driving the motor(s) 102 and brakes after the enable button 216 is pushed. An app 624 (not shown) could also direct/instruct PCB 210 to direct the trailer after the enable button 216 is pushed. There is an indicator bar 206 that ideally goes around and over a sleeve 208. This indicator 206 would be lit and visible any time that the trailer was operational or on standby.

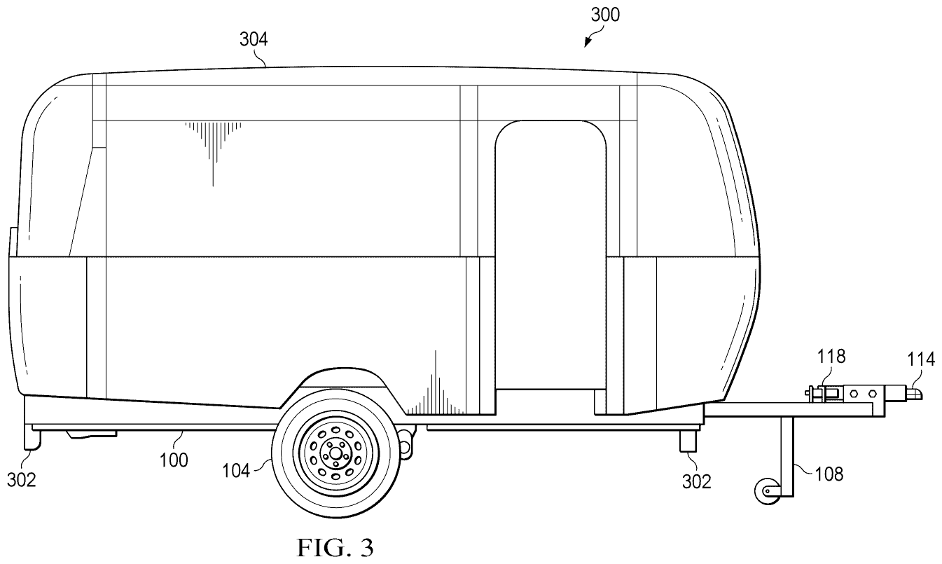

FIG. 3 is a side view of a trailer 300. Trailer 300 includes at least one electric motor motivating its wheels and electrically operated brakes which are adapted to be controlled by the system and method of the present disclosure. The trailer's frame 100 is mostly hidden underneath the main cabin 304. The hitch coupler 114, load sensor 118, wheels 104, and tongue jack 108, are easily seen. There could also be electromechanical leveling jacks 302 on the 4 corners to lift and stabilize the trailer 300 that would be operated by the central computer 116 and could auto-level the trailer 100. This trailer could have a cabin, or only a flat bed for hauling, or as a boat trailer, or food truck, just as examples, not by limitation.

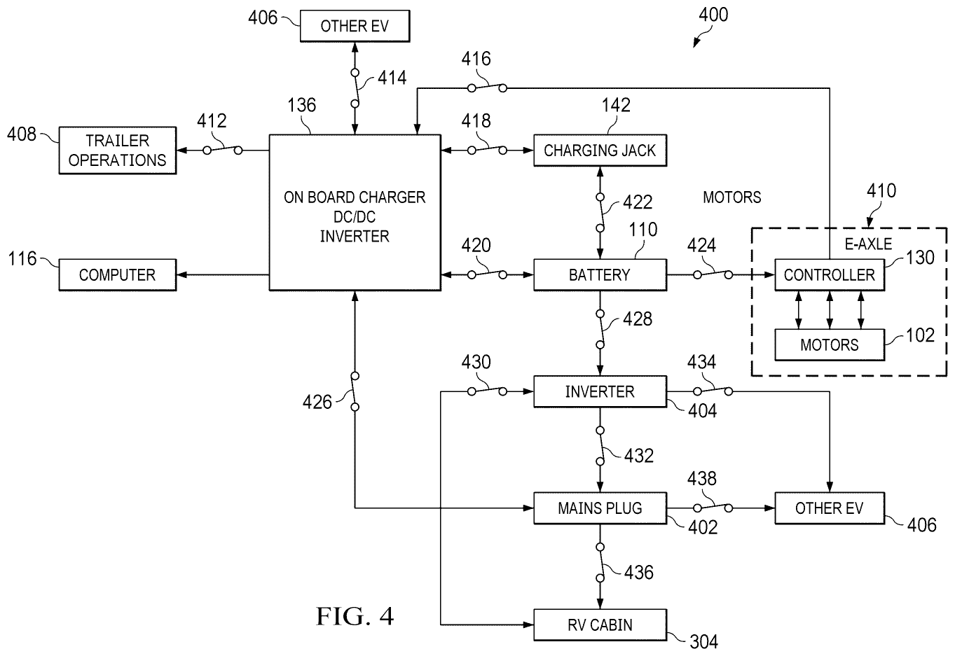

FIG. 4 is a block diagram of the electrical system of the system of the present disclosure 400. Switches 412-438 can be any type of switch, a mechanical switch, relay, transistor, MOSFET, PNP, NPN, IGBT, TRIAC, intrinsic, or any other similar device.

The system is commanded by the central computer 116, but most of the electrical work is done by the on board charger (OBC) 136. The OBC 136 has battery charging capabilities but also DC to DC conversion at a wide variety of voltages, both input and output, and the OBC 136 has AC inverter capabilities as well, but it can usually only perform one of these 3 high power functions at a time. When not charging, the battery 110 generally feeds the OBC 136 through a switch 420, and the OBC 136 feeds appropriate voltage to the computer 116. The computer can control the switch 424 and allow power to the motor controller 130. When directed by the computer 116, the motor controller ideally generates 3 phase power for the motors 102 to propel trailer 300.

When braking, computer 116 can direct the motor controller 130 to receive 3 phase power from the motors 102 and send that power through switch 416 to the OBC 136, that then provides regenerative charging to the battery 110 through switch 420. Similarly, this path could be used to charge the battery while driving downhill, while decelerating, or on flat roads, effectively borrowing power from a towing vehicle or the incline. The process could be reversed, and power could come from the battery 110 to the controller 130 helping drive the motors 102 and wheels 104 when going uphill or accelerating, or when a strong force on the sensing trailer hitch 200 is detected by the computer 116.

Normally when the battery is being charged the power is introduced through the charging jack 142 and switch 418 is activated by the computer 116 or the OBC 136, with the OBC 136 receiving this power where it is then directed through switch 420 to the battery 110. Some situations might require sending power out the charging jack 142 rather from it. In the situation where a towing vehicle wanted to charge itself or extend its range switch 422 could be set to allow power from the battery 110 to the charging jack 142 that the towing vehicle could be connected to. A similar situation might require switch 420 to allow power to the OBC 136 where it converts the power to a different voltage and then enables switch 418 to allow that power to go to the charge jack 142.

Camping trailers often park in a trailer park where there is an AC mains plug or shore power is available. These plugs are usually 30 or 50 amps and 240 volts AC with a neutral and a ground. That power can be introduced into the intelligent electric trailer 300 through mains plug 402 and switch 426 allows it to flow into the OBC 136. The OBC 136 can then best use this power by enabling switch 420 to charge the battery 110 and enabling switch 436 to allow the RV cabin 304 functions to run off of mains power directly and simultaneously to the battery 110 charging. One might need to power the mains from the trailer and this could be accomplished in one of two ways, the first would be to enable transistor 420 to allow power from the battery 110 to flow to the OBC 136 where it would use its inverter to generate AC power that would flow through switch 426 to the mains plug. But the OBC might be converting power for some other use and a second way to power the mains would be to enable switch 428 allowing power to go from the battery 110 to the freestanding inverter 404 and then through switch 432 to the mains plug 402 where it could be shared with the mains. Switch 438 could be enabled to allow AC power to go to other EVs or the power from the inverter 404 could go through switch 434 and power other EVs. An additional inverter like 404 could be part of the OBC 136 so that battery 110 charging and AC power to the cabin 304 could occur simultaneously.

When switch 412 is enabled trailer operations 408 could be powered by the OBC 136. Trailer operations are the electromechanical, brakes, jacks, pumps, that are not necessarily 120 volts, but possibly 12 VDC or 48 VDC, for example but not by limitation. It could be more efficient to run trailer operations like HVAC from DC, or some might be from AC, the computer should determine this and use the best path.

Other EVs might need or provide power. Enabling switch 414 would allow a port for other EVs 406 to receive power from the OBC 136 at the voltage they need. Similarly if the intelligent electrical trailer 300 needed power it could enable switch 414 to allow power to flow from an other EV 406 or solar panels to the OBC 136 where it could use that power as needed, for RV cabin 304 functions or battery 110 charging, or for powering the motors 102.

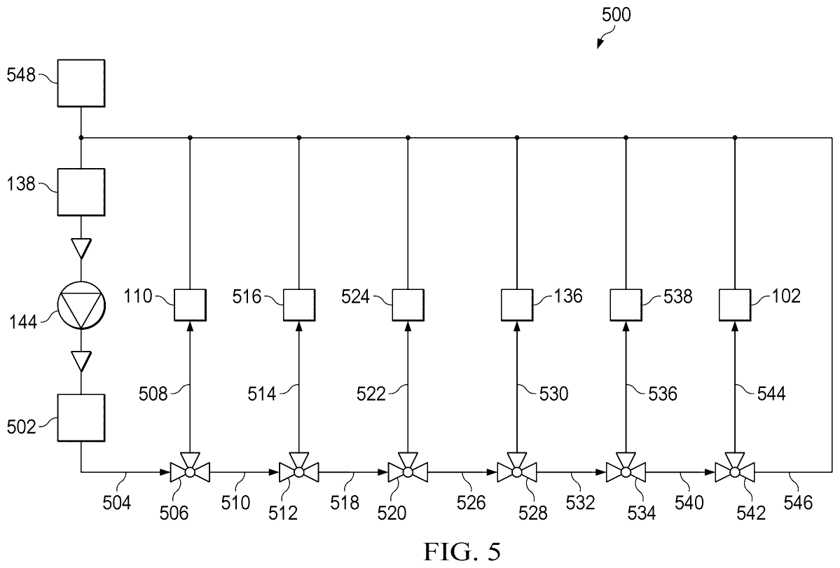

FIG. 5 depicts a block diagram of the intelligent electric trailer's liquid coolant loop 500. The term “coolant” is meant to mean a fluid that can transfer either a cooling potential or a heating potential, depending on the need of the component that needs temperature change.

The coolant pump 144 pumps fluid to a positive temperature coefficient (PTC) heater 502. The central computer 116 uses sensors inside the PTC 502 to determine if the fluid is of sufficient temperature to accomplish the intended heating or cooling. If the temperature of the fluid is too low then the PTC 502 heats the fluid to a desired temperature, otherwise the fluid simply passes through the PTC 502 via path 504 to the 3 way valve 506.

The valve 506 can determine whether the fluid goes towards the battery 110 via the path 508. The fluid going through the battery 110 heating the battery 110 and then passes to the radiator/fan combination 138 before being pumped again by the pump 144. If the valve 506 is set the other way it allows fluid to pass via path 510 to 3 way valve 512.

The valve 512 can determine whether the fluid goes towards the trailer cabin's radiant floor heating 516 via the path 514. The fluid going through the radiant floor heating 516 heats it and then passes to the radiator/fan combination 138 before being pumped again by the pump 144. If the valve 512 is set the other way it allows fluid to pass via path 518 to 3 way valve 520.

The valve 520 can determine whether the fluid goes towards the trailer cabin's hot water storage 524 via the path 522. The fluid going through the hot water storage 524 heats it and then passes to the radiator/fan combination 138 before being pumped again by the pump 144. If the valve 520 is set the other way it allows fluid to pass via path 526 to 3 way valve 528.

The valve 528 can determine whether the fluid goes towards the OBC 136 via the path 530. The fluid going through the OBC 136 cools it because the OBC generates heat and then passes to the radiator/fan combination 138 before being pumped again by the pump 144. If the valve 528 is set the other way it allows fluid to pass via path 532 to 3 way valve 534.

The valve 534 can determine whether the fluid goes towards the HVAC 538 which is a heat pump, via the path 536. The fluid going through the HVAC 538 could either cool the HVAC 538 or cool it because the HVAC 538 can generate either hot or cold and then the fluid then passes to the radiator/fan combination 138 before being pumped again by the pump 144. If the valve 534 is set the other way it allows fluid to pass via path 540 to 3 way valve 542.

The valve 542 can determine whether the fluid goes towards the drive motors 102 via the path 544. The fluid going through the drive motors 102 cools them because the motors 102 generate heat and then passes to the radiator/fan combination 138 before being pumped again by the pump 144. If the valve 542 is set the other way it allows fluid to pass via path 546 directly to the radiator/fan combination 138 before being pumped again by the pump 144.

There is a coolant fluid tank 548 that keeps the system topped off and allows for expansion or contraction due to temperature changes or evaporation of the fluid.

The radiator/fan 138 combination has a sensor that communicates with the central computer 116 which then determines if the fan 138 needs to be driven or not, or to what level, depending on the temperature requirements of the components 110, 516, 524, 136, 538, or 102. The radiator/fan 138 would ideally have dampers that would seal the radiator when the fan wasn't being driven, when heat is trying to be conserved rather than exhausted to the ambient atmosphere.

The order in which the major components 110, 516, 524, 136, 538, 102 were shown in FIG. 5 was arbitrary and could be arranged in a different order to be the most efficient, depending on the actual temperature needs.

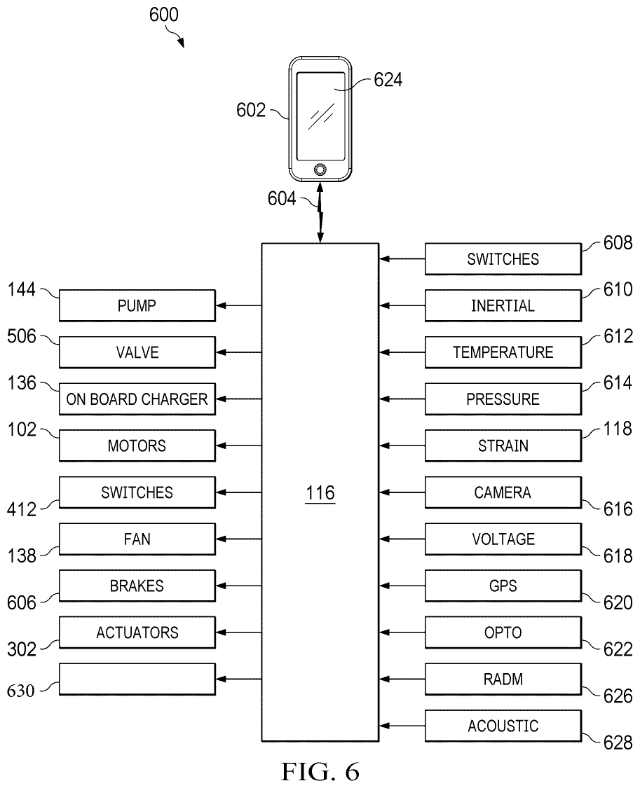

FIG. 6 depicts in a block diagram many of the components, sensors, and processes that the central computer controls or communicates with 600. The central computer 116 is in communication with an app in a users' cell phone 602 via Bluetooth 604. The central computer 116 would also have wireless connectivity with the internet via wi-fi or cellular connections. The app 624 would allow the user to set various modes of propelling the intelligent trailer. These modes could include: “wheelbarrow mode”, “hill climb mode”, “acceleration mode”, “driving mode”, “parasitic charging mode” and others.

Wheelbarrow mode would allow the user to control the intelligent electric trailer 100 as it self-motivates. The central computer 116 would receive this initial mode command via the user's cell phone 602, through the app 624 and Bluetooth communication 604. The trailer 100 would move at very low speed in order to park it or move it to the tow vehicle. The input could be through the app 624 or read the input switches 608 or the strain gauge (load sensor) 118 and then send commands to the motors 102 and the brakes 606 to move the trailer as requested. The central computer 116 would follow the instructions of the app 624 or read the input switches 608 or the strain gauge 118 and then send commands to the motors 102 and the brakes 606 to move the trailer as requested. The central computer could use sensors such as the camera 616 or opto 622 sensors to avoid colliding with nearby objects. It could also use RADAR/LIDAR 626 or acoustic 628 sensors. The system could also include uniquely dedicated collision avoidance sensors 630. The intelligent trailer 100 could be told the license plate number of the tow vehicle to autonomously hitch to using the above sensors and processes. Brakes 606 could be used independently from each other to assist in tight turns, or tank turning, where one wheel's brake(s) 606 is locked and the other wheel's motor 102 drives trailer 100 in the tightest possible turn. Alternatively, wheels 104 could be driven by their respective motors 102 in opposite directions causing trailer 100 to spin around its center point.

Hill climb mode would allow the user to control the intelligent electric trailer 100 as it self-motivates. The central computer 116 would receive this initial mode command via the user's cell phone 602, through the app 624 and Bluetooth communication 604. The central computer would determine it's inertial orientation by reading the inertial sensor (gyroscope) 610. This would indicate if the intelligent electric trailer 100 was going uphill, downhill or level. The central computer 116 could also communicate with the motors 102 through their controller 130, and it could also receive information from the strain sensor 118 to determine present drive load. The central computer 116 could also use GPS 620 to determine precise speed that would be included in the calculations to help give the best power solution to help the trailer 100 climb a hill. There could be two versions of the hill climb mode, the first would be climbing while driving. The trailer 100 would be under powered self-motivation and then apply additional power to climb a hill. The second possible hill climb mode would be a towed version. The trailer would not be assisting in self-motivation during flat driving, the trailer would assist in self-motivation only when climbing hills. This would allow a conventional towing vehicle to be of a smaller size and yet be able to climb steep hills while towing the trailer 100.

Acceleration mode would allow the user to control the intelligent electric trailer 100 as it self-motivates. The central computer 116 would receive this initial mode command via the user's cell phone 602, through the app 624 and Bluetooth communication 604. The central computer 116 would use a variety of sensors 608-620 to determine if the tow vehicle was attempting to accelerate, such as during passing or entering a freeway. There could be two versions of the acceleration mode, the first would be while driving. The trailer 100 would be under powered self-motivation and then apply additional power to accelerate as needed. The second possible acceleration mode would be a towed version. The trailer would not be assisting in self-motivation during driving, the trailer would assist in self-motivation only when accelerating. This would allow a conventional tow vehicle to be of a smaller size and yet be able to quickly accelerate while towing the trailer 100 and allow the battery to last much longer because it would not be used all the time.

Parasitic mode would allow the user to control the intelligent electric trailer 100. The central computer 116 would receive this initial mode command via the user's cell phone 602, through the app 624 and Bluetooth communication 604. Parasitic mode would allow the passively propelled trailer to charge its batteries by receiving energy from the motors 102. The motors would put a small mechanical drag on the tow vehicle, the charge coming from the e-axle 410. This energy would be used by the OBC 136 to charge the battery 110.

Driving mode might incorporate elements from all the other modes, wheelbarrow mode, hill climb mode, acceleration mode, and parasitic mode. Driving mode would allow the user to control the intelligent electric trailer 100. The central computer 116 would receive this initial mode command via the user's cell phone 602, through the app 624 and Bluetooth communication 604. It would attempt to make pulling the trailer 100 as easy and strain-less on the tow vehicle as possible while doing so in the most efficient way possible. There would never be very much pulling or pushing on the hitch in this mode. The ideal mode for an unskilled tow vehicle driver, or one with an underpowered tow vehicle.

The central computer 116 would constantly monitor the pressure of the tires using pressure sensor 614 input. The computer would be constantly monitoring the ambient air temperature sensor 612, looking for freezing or overly hot conditions. The computer 116 would be monitoring the inertial sensor 610 for fishtailing motions which could be corrected by applying timely braking 606 or warnings through the app 624.

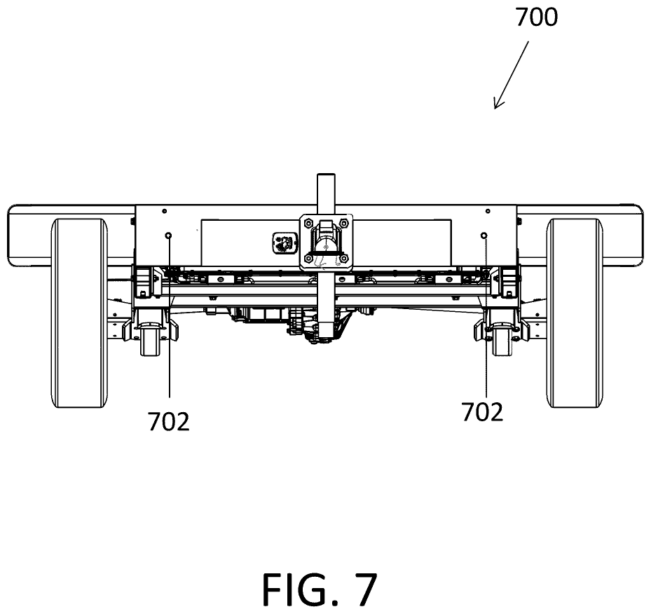

FIG. 7 depicts the front of a trailer 700 adapted/fitted with multiple dedicated collision avoidance sensors 702. These sensors 702, could be used for purposes other than collision avoidance or they could be dedicated to only collision avoidance. The back of the trailer would look very similar to the front to also include these sensors 702.

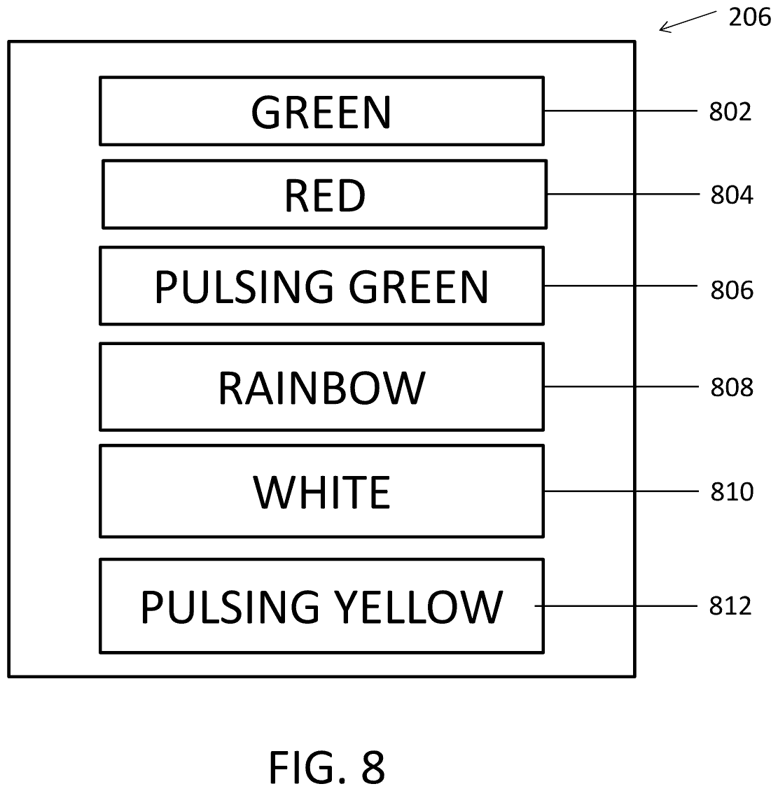

FIG. 8 depicts a system condition/status indicator 206 of the system of the present disclosure. On the indicator 206 are several elements 802, 804, 806, 808, 810, 812. The first element is Green 802 which shows the motor is on. The second element is Red 804 that shows the trailer is braking. The third element is pulsing green 806 which shows that the trailer is charging. The next element is rainbow in color 808 indicating the trailer is on standby. The next element is white 810 and when placed on the tongue 106 of the trailer would be a safety light to keep people from banging their shins on the tongue 106 in dark conditions. The last indicator element would be yellow 812 (solid or preferably pulsing) which would indicate an error or hazard situation. This indictor group 206 could be a subset or superset of this list. Their order could be changed and their colors could be modified. This indicator 206 could be positioned on (such as attached to) the tongue 106 of the trailer or displayed in/on the app 624, or both.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An intelligent towing control system for use with a trailer having electrically operated brakes and at least one wheel motor, the intelligent towing control system comprising:
a microprocessor;
a load sensor;
an accelerometer;
said microprocessor in communication with the at least one trailer wheel motor;
said microprocessor in communication with the electrically operated brakes;
a mechanical connection to the trailer;
said microprocessor in communication with said accelerometer;
said microprocessor in communication with said load sensor;
said microprocessor in electrical communication with at least one battery;
wherein said microprocessor is adapted for controlling the at least one wheel motor and the electrically operated brakes to improve towing control of the trailer.

2. The intelligent towing control system of claim 1 further including a gyroscope.

3. The intelligent towing control system of claim 1 further including a GPS.

4. The intelligent towing control system of claim 1 further including a breakaway sensor.

5. The intelligent towing control system of claim 1 further including a collision sensor.

6. The intelligent towing control system of claim 1 further including a moisture sensor.

7. The intelligent towing control system of claim 1 further including a temperature sensor.

8. The intelligent towing control system of claim 1 further including an ultrasonic sensor.

9. The intelligent towing control system of claim 1 further including a RADAR sensor.

10. The intelligent towing control system of claim 1 further including a LIDAR sensor.

11. The intelligent towing control system of claim 1 further including an infrared sensor.

12. The intelligent towing control system of claim 1 further including a tire pressure sensor.

13. The intelligent towing control system of claim 1 further including a proximity detector.

14. The intelligent towing control system of claim 1 further including wireless connectivity.

15. The intelligent towing control system of claim 1 further including a cell phone app.

16. The intelligent towing control system of claim 1 further including a status indicator.

17. The intelligent towing control system of claim 1 further including a camera.

18. The intelligent towing control system of claim 1 further including an electromechanical leveling jacks.

19. The intelligent towing control system of claim 1 further including a DC to DC converter.

20. The intelligent towing control system of claim 1 further including an AC to DC converter.

21. The intelligent towing control system of claim 1 further including a heat pump.

22. The intelligent towing control system of claim 1 further including a universal mounting plate.

23. The intelligent towing control system of claim 1 further including a NACS connector.

24. The intelligent towing control system of claim 1 further including solar panels.

25. The intelligent towing control system of claim 1 further including a joystick.

26. A method for controlling the towing mode of a trailer attached to a towing vehicle, the trailer having electrically operated brakes and at least one wheel motor, the method comprising:
measuring the force of the trailer on the towing vehicle;
measuring the acceleration condition of the trailer;
measuring the angular direction change of the trailer;
obtaining a result of the force, acceleration and angular direction change of the trailer;
adjusting the towing mode of the trailer based on said result.

27. The method of claim 26 wherein the towing mode is wheelbarrow mode.

28. The method of claim 26 wherein the towing mode is hill climb mode.

29. The method of claim 26 wherein the towing mode is acceleration mode.

30. The method of claim 26 wherein the towing mode is driving mode.

31. The method of claim 26 wherein the towing mode is parasitic charging mode.

32. The method of claim 26 wherein the towing mode is efficiency mode.

33. The method of claim 26 wherein the result provides sway control.

34. The method of claim 26 wherein the result provides breakaway condition controlled braking.

35. The method of claim 26 wherein the result provides traction control.

36. The method of claim 26 wherein the result provides anti-roll away detection.

37. The method of claim 26 wherein the result provides collision avoidance.

38. The method of claim 26 wherein the result provides trailer propulsion.

39. The method of claim 26 wherein the result provides trailer braking.

40. The method of claim 26 wherein the result provides control by wireless app.

41. The method of claim 26 wherein the result provides auto hitch capabilities.

42. The method of claim 26 wherein the result provides self-motivation.
